(19) United States
(12) Patent Application Publication
(10) Pub. No.: US 2010/0179953 A1
(43) Pub. Date: Jul. 15, 2010

(54) INFORMATION PRESENTATION SYSTEM, INFORMATION PRESENTATION METHOD, AND PROGRAM FOR INFORMATION PRESENTATION

(76) Inventors: Masaki Kan, Tokyo (JP); Yoshihiro Kajiki, Tokyo (JP); Nami Uchida, Tokyo (JP)

Correspondence Address: Mr. Jackson Chen, 6535 N. STATE HWY 161, IRVING, TX, 75039, US

(21) Appl. No.: 12/602,970

(22) PCT Filed: Jun. 2, 2008
(86) PCT No.: PCT/JP2008/060152

§ 371 Date: Dec. 3, 2009

(30) Foreign Application Priority Data
Jun. 5, 2007 (JP) 2007-149371

(51) Int. Cl. G06F 17/30

(52) U.S. Cl. 707/741; 707/769; 707/E17.014; 707/781; 707/E17.005; 707/E17.002

(57) ABSTRACT

An information presentation system comprises a time-series search processing unit 1, a time-series search input/output unit 2, a period information extraction unit 4, and a period information presentation unit 3. The period information presentation unit 3 provides period information, extracted by the period information extraction unit 4, to the time-series search input/output unit 2, which presents the period information to a user.

### CROSS-REFERENCE TO RELATED APPLICATIONS

The present application claims priority from Japanese Patent Application 2007-149371 (filed on Jun. 5, 2007) the content of which is hereby incorporated in its entirety by reference into this specification.

### TECHNICAL FIELD

The present invention relates to an information retrieval technology, and more particularly to a system, method, and program for presenting information used for information retrieval.

### BACKGROUND ART

With widespread use of Web search systems, such as Google (registered trademark), full text search systems for electronic files and the like have been commonly used. Using a search system, a user searches for information on a daily basis. Today, the major trend in the full text search systems for electronic files is that an index for, high-speed search is created in advance and a user searches through electronic files using this index. Examples of such information retrieval systems are described in Patent Document 1 and Non-Patent Document 1.

An N-gram based method and a morphological analysis method are known as a technology for creating an index (Non-Patent Document 1).

An index created by those methods, which is generally uncompressed, requires a large amount of storage capacity that is about 200-300% of the capacity of the original documents.

Another problem is that it is difficult to update this index dynamically.

A user searches for information using this index. This means that the user can get a search result of search target data existing at the time the index was created or updated.

For example, if the index has been created based on search target data which is data of one-day before the search, additions or updates that have been made for the search target data after the index creation time are not reflected on the search result.

Therefore, there is a need for search target data to be captured onto an index in a more real-time manner as possible. The technologies for this need are described in Patent Document 1 and Patent Document 2.

Patent Document 1 discloses a document search apparatus that, with an index of newly registered document files created in a memory, a document search unit uses both index data on new document data stored in a memory and index data on existing document files stored in a disk apparatus to search through document files. Patent Document 2 discloses a document search apparatus that when registering a new document in an index, registers the document into a sub-indexes smaller than a main index and at a search time, accesses each index to combine the result into the search result.

Patent Document 3 discloses the configuration of an information providing server (time machine center server) installed on a service provider side for storing and managing history information (public information) indicating historical public events classified by genre and for storing and managing history information (personal information) indicating user's personal events registered in advance on a user basis. In response to an information browsing request from a third person, this information providing server searches for the requested history information and provides information to a user terminal on the browsing user side. The history information is provided to a user in one of three service modes: “time specification travel”, “event search travel”, and “personal time travel”. “Time specification travel” is an information providing service that receives a browsing request from a browsing user simply specifying what time of past events he or she wants to browse and, in response to this request, searches for the public events, which occurred at or around a specified time, on a genre basis for providing the information to the user terminal on the browsing user side. The general public information database on the information providing server side individually stores and manages the history information (public information) indicating the past events by genre. Each record of the general public information database has items each including “genre”, “year information”, “month information”, and “day information” indicating the year/month/day on which an event occurred, “level” of topicality (importance), “title (index)”, and “information content”. This system searches through the information stored in the database.

### Patent Document 1:

Japanese Patent Kokai Publication No. JP-1-19-223152A

### Patent Document 2:

Japanese Patent Kokai Publication No. JP-H7-146880A

### Patent Document 3:

Japanese Patent Kokai Publication No. JP2002-108909A

### Non-Patent Document 1:

Kita Kenji, Tsuda Kazuhiko, Shishibori Masamiki “Information Search Algorithm”, KYORITSU SHUPPAN CO., LTD, Jan. 1, 2002, pp. 6, pp. 160-179

### DISCLOSURE OF THE INVENTION

### Problems to be Solved by the Invention

In the information retrieval systems described above, a user sometimes fails to reach the information in the same way as the user did in the past even if the same operation as that of the past search query is performed.

The reason is that, in a system where search target information sources are increased or updated daily, an addition or an update is made daily also to the search index and, so, even if the user performs the same search query, the search system sometimes returns different search results.

In view of the foregoing, it is an object of the present invention to provide an information presentation system, method, and program which provide a user with information used for identifying time information necessary for information retrieval and the like.

### Means to Solve the Problems

To solve the problems described above, the invention disclosed by this application provides the following general configuration.

A system in one aspect of the present invention comprises a search unit that selects a search index based on time information, which is used as a search base point, and performs search processing, the search index being partitioned on a time-series basis; and an extraction unit that extracts period information from a predetermined information source, the period information including information which serves as a marker of the time information, wherein the search unit performs the search processing according to the period information extracted by the extraction unit.

In the present invention, the predetermined information source includes an information system.

In the present invention, the system may further comprise a presentation unit that presents the period information extracted by the extraction unit.

In the present invention, the system may further comprise a period information accumulation unit that records therein the period information extracted by the extraction unit.

In the present invention, the system may further comprise a period information input/output unit that changes the period information, extracted by the extraction unit, and/or registers the period information in the period information accumulation unit.

In the present invention, the system may further comprise a period information search unit that accepts a search keyword which is received via a user interface and which is for limiting the period information, searches through the period information recorded in the period information accumulation unit, extracts the period information including the keyword, and outputs the extracted period information to the presentation unit.

In the present invention, the system may further comprise a period information search unit that receives a search keyword, searches through the period information recorded in the period information accumulation unit using the search keyword, and provides time information, which is made to correspond to the period information acquired by the search, to the search unit.

In the present invention, in performing an information retrieval with time information specified as a search condition, the period information, which is presented by the presentation unit and selected by a user, may be used by the search unit as time information of a search condition to eliminate a need for searching for time information used as the search condition.

In the present invention, the system may further comprise a search input/output unit that presents the period information, presented by the presentation unit, to a user via an interface.

In the present invention, the search input/output unit may convert user selected period information to a format acceptable by the search unit and enters the converted period information into the search unit.

In the present invention, the presentation unit may provide the period information, extracted by the extraction unit, to the search input/output unit, the search input/output unit may present the period information to a user and, when the user enters time information into the search unit as a search condition, the presented period information may be made available for use as information for determining time information.

In the present invention, the extraction unit may extract the period information using an index, included in the search unit, as the information source.

In the present invention, the extraction unit may select an index, which is partitioned on a time-series basis, for a search based on search base-point information and extract the period information.

In the present invention, the system may further comprises a user rule accumulation unit that stores rules for extracting the period information according to users, wherein the extraction unit extracts the period information from the information source based on a user-specific rule stored in the user rule accumulation unit.

In the present invention, the system may further comprises a user rule accumulation unit that stores rules for presenting the period information according to users, wherein the presentation unit presents the period information, extracted by the extraction unit, based on a user-specific rule stored in the user rule accumulation unit.

In the present invention, the predetermined information source may include a scheduler system.

In the present invention, the system may further comprises a scheduler system that accepts schedule information, entered by a user or acquired from the information source, and registers the schedule information in a scheduler database, wherein the schedule information is used as the extracted period information, the scheduler database is used as the period information accumulation unit in which the period information is recorded, and the presentation unit presents the period information from the scheduler database and provides the period information to the search unit.

A method according to the present invention comprises the steps of:

extracting period information from a predetermined information source, the period information including information which serves as a marker of time information; and

in performing a search processing by selecting a search index based on the time information to be used as a search base point, the search index being partitioned on a time-series basis, performing the search processing according to the extracted period information.

A program according to the present invention causes a computer to perform the processing comprising:

extracting period information from a predetermined information source, the period information including information which serves as a marker of time information; and

in performing a search processing by selecting a search index based on the time information to be used as a search base point, the search index being partitioned on a time-series basis, performing the search processing according to the extracted period information.

### EFFECT OF THE INVENTION

According to the present invention, information necessary for information retrieval and used for identifying time information may be provided.

### BRIEF DESCRIPTION OF THE DRAWINGS

FIG. 1 is a diagram showing the configuration of a first invention example of the present invention.

FIG. 2 is a diagram schematically showing an example of the user interface of a time-series search input/output unit in a first exemplary embodiment of the present invention.

FIG. 3 is a diagram schematically showing an example of the user interface of the time-series search input/output unit in the first exemplary embodiment of the present invention.

FIG. 4 is a flowchart showing the operation of search processing in the first exemplary embodiment of the present invention.

FIG. 5 is a flowchart showing the operation executed when the time specification interface is used in the search processing in the first exemplary embodiment of the present invention.

FIG. 6 is a flowchart showing the operation executed when the period information selection interface is used in the search processing in the first exemplary embodiment of the present invention.

FIG. 7 is a flowchart showing the operation of the period information extraction processing in the first exemplary embodiment of the present invention.

FIG. 8 is a diagram showing the configuration of a first modification of the first exemplary embodiment of the present invention.

FIG. 9 is a diagram showing the configuration of a second modification of the first exemplary embodiment of the present invention.

FIG. 10 is a diagram showing the configuration of a second exemplary embodiment of the present invention.

FIG. 11 is a diagram showing the configuration of a third exemplary embodiment of the present invention.

FIG. 12 is a diagram showing the configuration of a modification of the third exemplary embodiment of the present invention.

FIG. 13 is a diagram showing a modification of a period information extraction unit in the first exemplary embodiment of the present invention.

FIG. 14 is a diagram showing an example of the configuration of a time-series search processing unit in the first exemplary embodiment of the present invention.

FIG. 15 is a diagram showing the configuration of a fourth exemplary embodiment of the present invention.

FIG. 16 is a diagram schematically showing an example of the user interface in the fourth exemplary embodiment of the present invention.

### EXPLANATIONS OF SYMBOLS

1,21 Time-series search processing unit
2,22 Time-series search input/output unit
3,3′ Period information presentation unit
4 Period information extraction unit
4′ Period information extraction unit
4″ Period information extraction unit
5 Period information accumulation unit
6 Information system
7 User rule accumulation unit
8 Rule input unit
9 User authentication unit
10 Search index
11 Partitioned index
12 Period information retrieval unit
13 Period information retrieval unit
20 Scheduler system
23 Schedule presentation unit
24 Schedule input unit
25 Schedule DB
26 Other information system
27 User
41 Period information input/output unit
100 Past index storage unit
101 Document storage unit
102 Index registration unit
103 Search unit
110 Latest index
111-114 Partitioned index

### PREFERRED MODES FOR CARRYING OUT THE INVENTION

The present invention will be described more in detail below with reference to the drawings.

An information presentation system of the present invention comprises a time-series search processing unit (1), a time-series search input/output unit (2), a period information presentation unit (3), and a period information extraction unit (4), wherein the period information presentation unit (3) provides period information, extracted by the period information extraction unit (4), to the time-series search input/output unit (2), which presents the period information to a user. Such a configuration allows a search user, who is going to enter time information into the time-series search processing unit (1) as the search condition, to use the presented period information as information for determining the time information. With indexes partitioned and recorded on a time-series basis, the time-series search processing unit (1) selects an index, corresponding to the base point corresponding to the time information specified implicitly or explicitly as the search condition, and performs the search processing.

In addition, so that a search user can select from presented period information and use the time information, which is related to the selected period information, as the search condition to be specified for the time-series search processing unit (1), the time-series search input/output unit (2) converts the information to a format acceptable by the time-series search processing unit (1) and enters the converted information as the search condition.

According to the present invention, period information, which is related to a date and a time, is presented to allow a user to select the related information so that the user can either recognize specific time information or enter time information, corresponding to the selected period information, directly into the system. As a result, when the user enters time information into the system, the user is able to enter into the system the time information to be specified even if the user does not remember the actual date or time.

In general, in order that a user can reach a file or an information source on the web the user discovered in the past, the user memorizes the path or the URI (Uniform Resource Identifier) of the file. However, there is a case wherein the user does not memorize the path or the URI of a file but sometimes memorizes only how to reach the information. More specifically, in a situation where a search engine is widely used as it is today, the user memorizes only a search query that was input to the search engine and uses that query again for the search. For example, the user memorizes a query “a web page searched for using the keyword OO three days ago”.

However, because the index of the search engine is updated or increased daily, the user may acquire different search results even if the same keyword is used for the search. This sometimes results in a situation in which the user cannot reach a file or information again that could be reached before.

There is a possible need for a user to acquire the same search result as that in the past.

In the present exemplary embodiment, the partitioned indexes, created by partitioning the search index on a time-series basis, are prepared and, based on the information on the search base point, one of the partitioned indexes is selected for the search processing. The user enters time-axis information such as a date/time to operate the time axis of the search result. The search function that operates the time-axis of the search result is classified roughly into the following two.

(A) First, the search function based on a past view point is provided. This function allows the user to go back to a user-specified point in time in the past to search for information using the characteristic of the search target information at that point. Because the search result at that time point may be reproduced as described above, the user will be able to access the original information in future, which was once reached by a search, using the same method as that used in the past.

(B) Second, the search function for a limited time-axis range of a search target is provided. This function is the search function for information that has changed in a specified time zone and helps a user access information based on the user's temporal memory.

These functions enable the user to operate the time axis for the search processing.

However, when a search is performed by operating the time-axis, a user sometimes finds it difficult to accurately remember the date/time to which to go back or the date/time zone to be limited.

For example, assume that a user wants to get a search result at a point in time, that is, “a date on which OO occurred”.

In this case, the user has to follow the following procedure.

(a) Investigate, in some way or other, the accurate information on the date on which “OO occurred” (for example, check the notebook) and

(b) Enter the date as the search condition.

That is, this procedure requires the following two stages of search:

“Search for retrieval condition”-->“Search for information retrieval”.

In a system, where the search is performed based on the time axis, the present invention allows a user to search for desired information even if the user fails to accurately remember information on the time or date the user must enter. This capability significantly increases the convenience and operability of the search processing. This is because the user memorizes information on the time or the date, which is specified by the user, not as accurate information such as a date but as date-related information such as an event. The present invention will be described below using exemplary embodiments.

### First Exemplary Embodiment

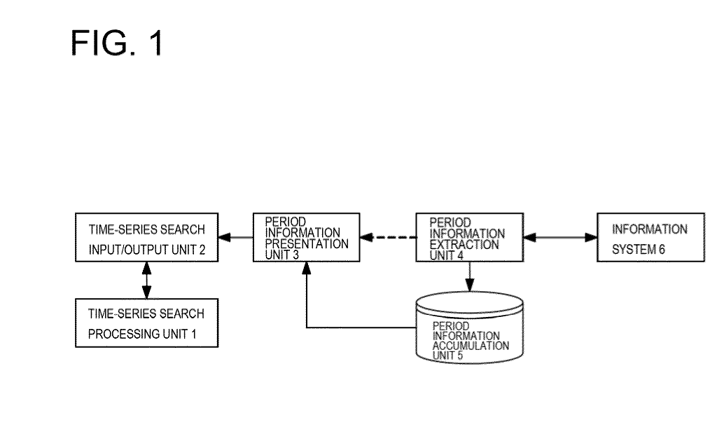

Referring to FIG. 1, a system in a first exemplary embodiment of the present invention comprises:

a time-series search processing unit 1 that explicitly or implicitly accepts time information as one of inputs of the search condition and performs information retrieval,

a time-series search input/output unit 2 that performs the input/output processing for a search condition and a search result for the time-series search processing unit 1,

a period information presentation unit 3 that presents information (called “period information”) related to a date or a time,

a period information extraction unit 4 that extracts period information, which will be presented, from an information system 6 that will be described later,

a period information accumulation unit 5 in which period information, extracted by the period information extraction unit 4, is accumulated, and

an information system 6 from which the period information extraction unit 4 extracts period information. The following describes those parts.

### <Time-Series Search Processing Unit 1>

The time-series search processing unit 1 extracts one or more pieces of information from multiple pieces of information according to the received search condition. More specifically, grep commands provided by UNIX (registered trademark) or a system such as a full-text search engine may be used.

In general, a word is entered as the keyword of the search condition and the information including the keyword is extracted and output as the result. The time-series search processing unit 1 outputs different search results by implicitly or explicitly receiving time information as the search condition.

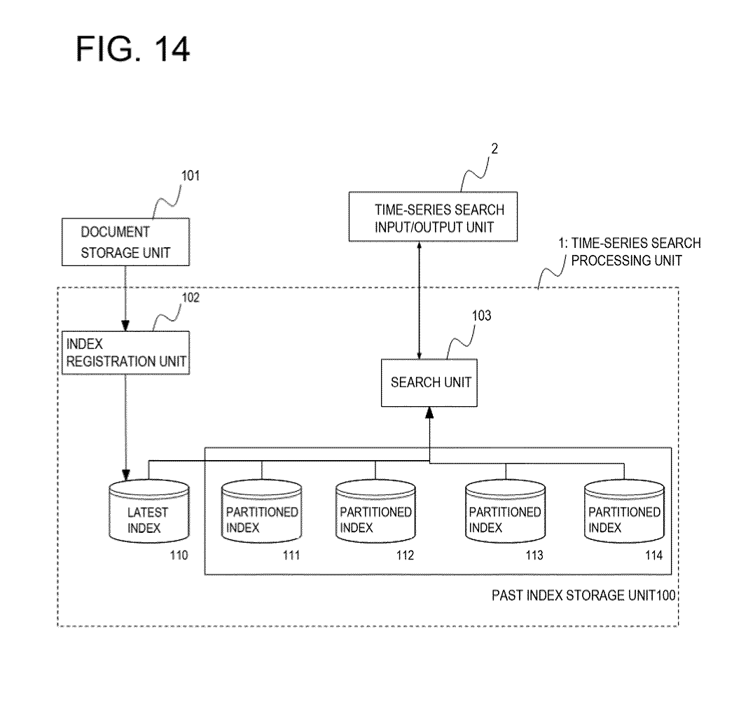

The time-series search processing unit 1, with the configuration such as the one shown in FIG. 14, receives time information as the search condition and performs the search processing by going back to the received time. Referring to FIG. 14, the time-series search processing unit 1 comprises an index registration unit 102, a search unit 103, and a past index storage unit 100. The past index storage unit 100 includes a plurality of partitioned indexes 111-114.

In FIG. 14, a document storage unit 101 stores search target documents. The document storage unit 101 may also be included in the time-series search processing unit 1. The document storage unit 101 may be any of the following:
Hard disk drive of a personal computer of the user,
External apparatus such as NAS (Network Attached Storage),
WWW (World Wide Web),
Intranet (web pages in a company), and so forth.

The search target documents may include electronic files, such as web pages and office documents stored in the storage units given above, or structured information stored in databases. When the search target documents include electronic files such as web pages and office documents, the document storage unit 101 in FIG. 14 corresponds to the information system 6 in FIG. 1. In this case, the information system 6 may be used as the document storage unit 101.

The index registration unit 102 creates the index of a search target document stored in the document storage unit 101 and registers it in a latest index 110.

The search unit 103 performs the search processing using the indexes 110-114 created by partitioning the search index on a time-series basis. The search unit 103 receives a search condition, such as a search keyword or a search time (for what time of documents the search processing is to be performed), from the time-series search input/output unit 2. The search processing result is supplied to the time-series search input/output unit 2.

The latest index 110 and the partitioned indexes 111-114 included in the past index storage unit 100 are indexes used for the search processing. Those indexes are partitioned into sections which are arranged on a time-series basis. Of those indexes, the partitioned index including the latest update is the latest index 110.

The index registration unit 102 creates the index data on a new document and an updated document and constantly registers the created index data in the latest index 110. Although the past partitioned indexes are configured by a total of four partitioned indexes in FIG. 14, the number of partitioned indexes is not limited but is increased as the indexes are further partitioned on a time series basis. The latest index 110 and the partitioned indexes 111-114 are saved in storage apparatuses such as a memory or magnetic disk apparatuses.

Those indexes may be saved in
Ordinary file format, or
Records in a database.

The latest index 110 and the partitioned indexes 111-114 may be saved in different storage apparatuses, one for each, or in the same storage apparatus. On an occurrence of a predefined partitioning trigger, the latest index (an object in which the index registration unit 102 registers index data) is created newly. The index that has been the latest index (latest index 110) becomes the second latest index that is one of the partitioned indexes. This structure may also be implemented by changing the registration path to the registration destination used by the index registration unit 102. The structure may also be implemented by copying the data in the latest index 110 to the past index storage unit 100 to create a new partitioned index, and by clearing the latest index 110.

When time information (or time section) used as the search base point is specified explicitly as the search condition, the partitioned index corresponding to the time section to which the time information belongs is selected for the search processing. If time information is not specified for the search condition, it is possible to select the latest index 110 by default for the search processing.

In the configuration shown in FIG. 14, indexes are classified and recorded on a time series basis and only indexes before a past base point are used for the search processing to perform the search processing based on the past base point.

Index addition/update processing may be performed speedily while achieving the effect described above. That is, because an index to be added or updated is a partitioned index in which only the addition/update (difference) generated during a fixed period of time is recorded, the storage capacity for the partitioned index may be small.

The configuration of the time-series search processing unit 1 is only required to be used for the search processing based on a past base point, and is not limited to the one shown in FIG. 14. For example, there are general-purpose search systems that search for time information on metadata attached to a search target file. For example, a find command available in the UNIX (registered trademark) system has an option that enables a file to be searched for using file access times and change times. Such search software may also be used as an example of the time-series search processing unit 1.

### <Time-Series Search Input/Output Unit 2>

The time-series search input/output unit 2 supplies a search condition to the time-series search processing unit 1, and receives a search result from the time-series search processing unit 1 and outputs the received result.

In addition, the time-series search input/output unit 2 presents the period information, received from the period information presentation unit 3, to a search user and functions as the search condition input interface.

This period information may be used only as auxiliary information for inputting time information as a search condition, or the period information itself may be used as an interface for inputting the time information.

When the presented period information is as the time information input interface, the period information cannot be supplied directly to the time-series search processing unit 1. Therefore, the time-series search input/output unit 2 may perform the function that converts the period information to a format acceptable by the time-series search processing unit 1 and supplies the converted period information to the time-series search processing unit 1.

An example of the actual time-series search input/output unit 2 may include a screen implemented on a web browser such as a WWW search engine or a command line interface such as Shell in CUI (Character User Interface).

### <UI Image, Example of UI Implementation>

Next, the following describes the user interface (UI) screen provided by the time-series search input/output unit 2.

In general, the time information is specified by entering a character string indicating a time {for example, arguments of cal command of UNIX (registered trademark)}, by selecting a character string indicating a time, or by specifying an actual date and time using a calendar or a clock.

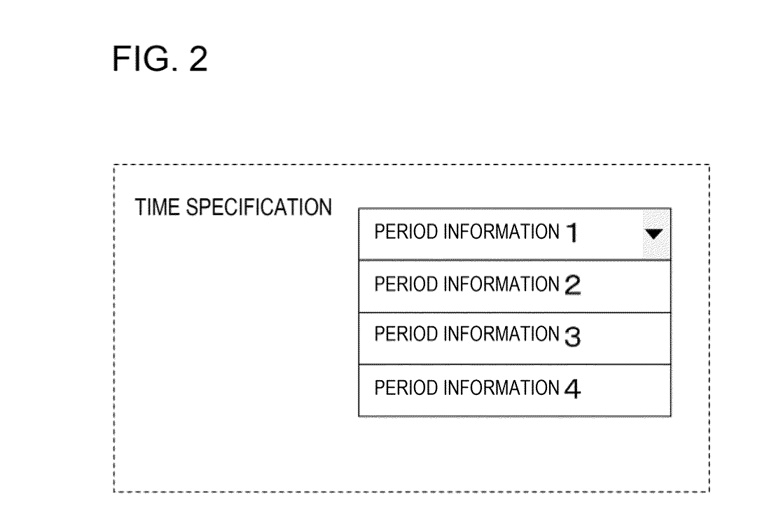

FIG. 2 is a diagram showing an example of the interface via which time information is entered by selecting period information in the present exemplary embodiment. In addition to a general window for entering a search keyword, the present exemplary embodiment provides a dropdown list {dropdown list in FIG. 2} from which period information is selected. The user selects period information from this list to specify the time, indicated by the selected period information, as an alternative for specifying an actual date/time.

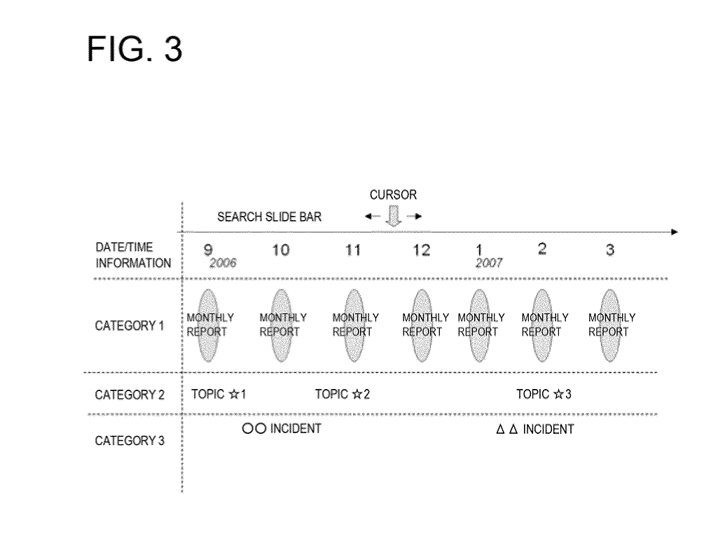

FIG. 3 is a diagram showing an example of an interface in which period information is displayed as a chronological table. Although presented as a chronological table in a form classified by category in FIG. 3, the period information may also be displayed, not in a classified form like this, but in a consolidated form.

The classification method is one of the following:
The contents of the period information are analyzed by natural language processing; and
The period information is classified according to the types of the information system 6 used as the information source.

The following describes FIG. 3 more in detail. A row “category 1” includes “Monthly” (monthly report) acquired from the information system 6. In this row, the entirety or a part of the contents of the monthly reports is displayed. To selectively display the contents, the title part indicating a topic is extracted, or words are extracted and words of high-importance are selected, for presentation.

“Topic ⋆ 1”, “Topic ⋆ 2”, and “Topic ⋆ 3” displayed in a row of “Category 2” and “OO incident” and “ΔΔ incident” displayed in a row of “Category 3” are examples of presented period information. The period information is arranged and displayed in the chronological table format on a time series basis.

In the example shown in FIG. 3, a slide bar at the top is used to specify a time. The slide bar is used to indicate the location, where the period information to be specified is shown, for specifying a time.

A time may also be specified by clicking period information displayed in a chronological format. A user may also read the chronological table and enter a time either via the calendar or by entering a character string.

When there are a large number of period information pieces, presenting all period information as the UI sometimes results in an interface difficult for a user to use. In such a case, instead of presenting all period information, the time information may be presented selectively. The selection method is that, with importance scores assigned to the period information, a high importance score is assigned the period information which is frequently selected by the user and the period information having an importance score equal to or higher than a predetermined value is presented as the UI. In this case, as additional means of the configuration in FIG. 1, the system further comprises a means that records user selections and updates the period information accumulation unit 5.

### <Implementation Example>

Actual implementation is achieved by modifying the user interface provided by the time-series search processing unit 1.

An alternative implementation mode is also possible in which there is provided only a user interface which overlays the user interface of the time-series search processing unit 1 and which provides information to the interface of the time-series search processing unit 1 or to the API.

### <Period Information Presentation Unit 3>

The period information presentation unit 3 performs the function to acquire period information, which should be presented to the search condition input/output screen, from the period information accumulation unit 5 and deliver the acquired period information to the time-series search input/output unit 2.

An alternative mode is that the system does not comprise the period information accumulation unit 5 but the period information presentation unit 3 directly receives the period information, acquired by the period information extraction unit 4, and presents the acquired period information to the time-series search input/output unit 2.

### <Period Information Extraction Unit 4>

The period information extraction unit 4 performs the function to extract period information from the information system 6 and save the extracted period information in the period information accumulation unit 5. An alternative configuration is that the system does not comprise the period information accumulation unit 5 but, instead, the period information extraction unit 4 presents the extracted period information directly to the period information presentation unit 3.

The period information extraction unit 4 accesses the information system 6 and retrieves necessary information. More specifically, the period information extraction unit 4 performs the operation similar to that of a crawler that collects web pages.

### <Period Information>

“Period information” refers to the information that serves as a marker (time marker, time landmark) representing time information to help a user to remember the time information that the user is going to specify.

According to the geographical concept, the period information is the information that serves as a geographical marker. For example, when we tell a destination to somebody else, we usually use a location we are familiar with. More specifically, we tell a location to somebody else using an expression such as “near OO station” or “near the Tokyo tower”.

The period information may be though of as a concept in which the concept described above is applied to time. An example is the Great Hanshin earthquake. The Hyogo Prefecture Southern Area earthquake in the seventh year of the Heisei era, which is the cause of the Great Hanshin earthquake, occurred at 5:46:52 am on Jan. 17, 1995. The user does not always remember the exact date and time at which this earthquake occurred.

On the other hand, this disaster name is sometimes used as the information indicating date/time or time zone. For example, the expression (phrasing) “around the date the Great Hanshin earthquake occurred” is sometimes used in daily conversations or some contexts to refer to the year of 1995 or the mid-1990s. That is, the word “Great Hanshin earthquake” may be used as the marker information that represents the period or the time at which the earthquake occurred.

Such information, which may be used as a marker indicating a period or a time, is referred to as “period information” in this specification.

Examples of the time information indicated by “Great Hanshin earthquake” (in general, this expression is supposed to indicate the point in time at which the Hyogo Prefecture Southern Area earthquake in the seventh year of the Heisei era occurred) are given below. To which time information the expression “Great Hanshin earthquake” refers depends on the context or the situation.
1900s (20th century);
Last half of 1900s (20th century);
1990s;
Mid-1990s;
1995;
January in 1995;
Jan. 17, 1995;
5:00 am on Jan. 17, 1995;
5:46 am on Jan. 17, 1995;
5:46:52 am on Jan. 17, 1995; and
Heisei era.

### <Period Information Accumulation Unit 5>

The period information accumulation unit 5 accumulates therein the period information acquired by the period information extraction unit 4. The period information accumulation unit 5 has a storage apparatus in which data is stored. The storage apparatus may be a single disk apparatus or a disk array apparatus composed of multiple disk apparatuses. The storage apparatus may be a magnetic optical apparatus or an array apparatus composed of a collection of magnetic optical apparatuses or may be a storage apparatus composed of a single or multiple semiconductor memories.

The period information accumulation unit 5 may also include a NAS (Network Attached Storage) or a DB (Data Base) system that has not only those storage apparatuses but also a calculation processing unit, such as a CPU, for input/output of files or data.

The system may comprise a means or a unit that allows a user to change the period information recorded in the period information accumulation unit 5 or to directly enter information for registering the period information.

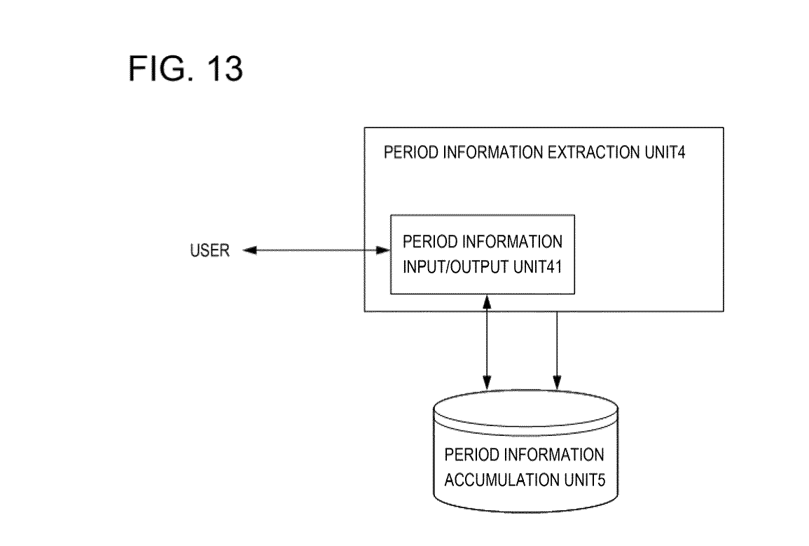

FIG. 13 is a diagram showing a modification of the present exemplary embodiment in which a period information input/output unit 41 is provided in the period information extraction unit 4 to provide the user with period information input/output function.

The period information input/output unit 41, though provided as a part of the period information extraction unit 4 in the example shown FIG. 13, may be provided either as a part of some other unit or as a standalone unit rather than a part of some other unit.

The period information input/output unit 41 performs the function that allows the user to browse already-registered period information (and time information associated with the period information) from the period information accumulation unit 5 or to correct the registered period information.

The period information input/output unit 41 also receives period information, created by the user using any given method, and newly records the received period information in the period information accumulation unit 5.

### <Information System 6>

The information system 6 functions as an information source from which the period information extraction unit 4 extracts period information.

Although there is one information system 6 in FIG. 1, any number of information systems may also be used in a composite manner as the information source.

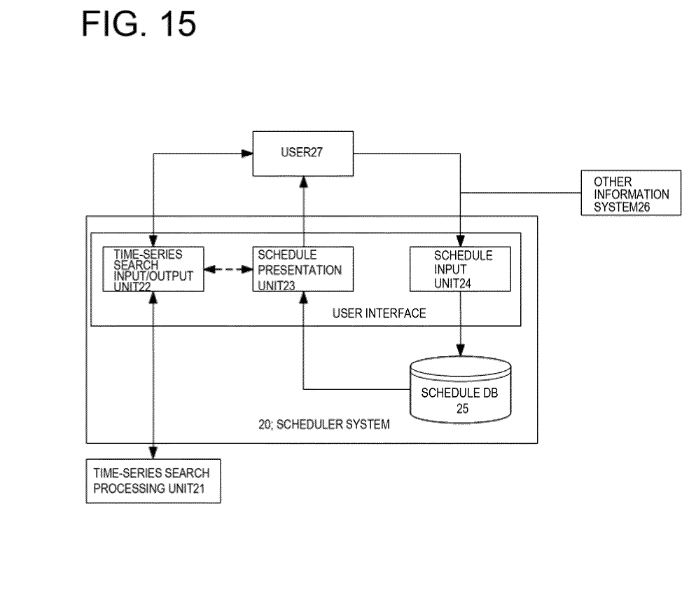

Although not limited thereto, at least one of the following is used as the information system 6.
WWW;
Portal site of intra-organization network;
Scheduler system (see fourth exemplary embodiment in FIG. 15);
News site or news DB;
Information system or storage apparatus that stores weekly reports or monthly reports {mail server or user's mail client software, etc.}; and
Weather, visual information (user's desktop screen or web page screen at an indicated point in time, or camera image at an indicated point in time).

The information system 6 may operate, not as the information source of the period information extraction unit 4, but as a means that registers period information. For example, when the period information defined by some organization is used by the time-series search processing unit 1 in the organization, the administrator of the time-series search processing unit 1 in the organization enters period information via the information system 6. When the time-series search processing unit 1 has the configuration shown in FIG. 14, the information system 6 that operates as a means that registers period information performs the function of the document storage unit 101 and the index registration unit 102.

The period information extraction unit 4 records the period information, acquired from the information system 6, in the period information accumulation unit 5.

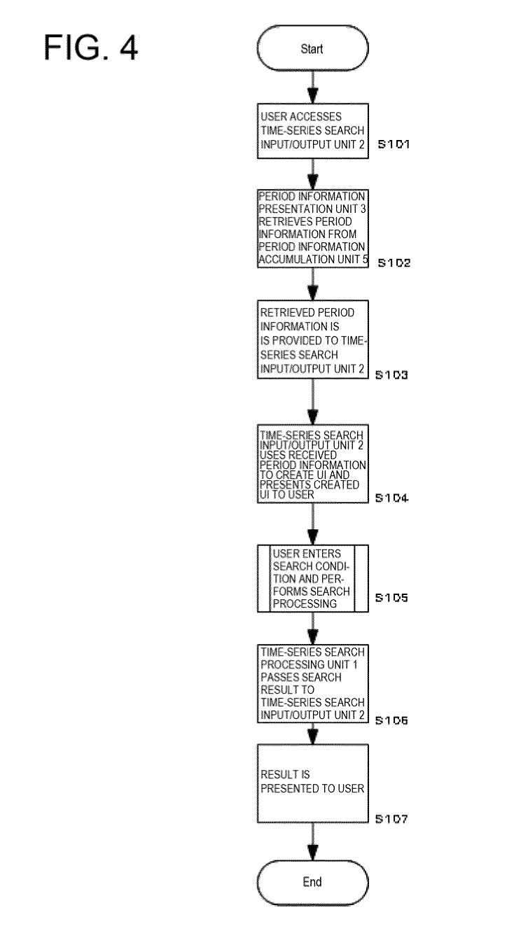

Next, the following describes the operation of the search processing in the present exemplary embodiment with reference to the flowcharts in FIGS. 4, 5, and 6.

First, the user accesses the time-series search input/output unit 2 to perform the search processing (step S101 in FIG. 4).

Next, the period information presentation unit 3 retrieves necessary period information from the period information accumulation unit 5 (step S102).

In step S102, instead of extracting period information from the period information accumulation unit 5, it is also possible that the period information extraction unit 4 accesses the information system 6 in real time to extract period information and that the period information presentation unit 3 provides the extracted period information to the time-series search input/output unit 2. This configuration eliminates the need for the period information accumulation unit 5, making extra storage areas available for other uses. However, this configuration degrades the performance and increases the amount of access to the information system 6.

The necessary period information is necessary for creating a UI in the time-series search input/output unit 2. With the example of FIG. 3, the creation of the chronological table from September in 2006 to March in 2007 requires that the period information, which indicates the time information in this period, be selected and retrieved. The time information in other periods is not required at this point in time.

If the function to scroll the chronological table is endowed in FIG. 3, the time information on other periods is necessary.

It is possible that the period information necessary after the scroll operation is delivered when the first screen is created or that steps S102-S104 are executed when a screen after the scroll operation is created.

Next, the period information presentation unit 3 provides the retrieved period information to the time-series search input/output unit 2 (step S103).

The time-series search input/output unit 2 uses the received period information to create a user interface and presents the created user interface to the user (step S104).

### <UI>

Steps S102-S104 may be executed before the user accesses the time-series search input/output unit 2 (step S101). A user interface, which is created in advance and with which period information is combined, may also be used in the operation.

In such a case, control is jumped from step S101 directly to step S105 in the flowchart in FIG. 4.

Next, the user enters a search condition via the provided user interface to start a time-series search using the search condition (step S105).

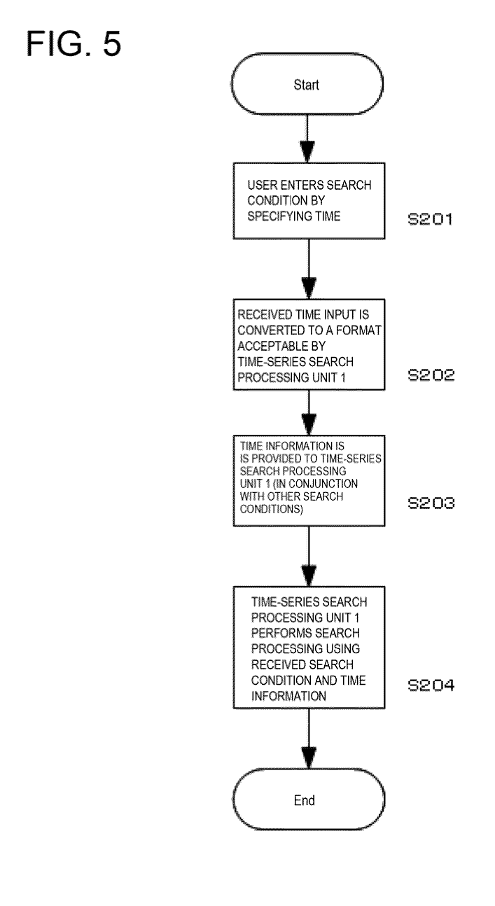

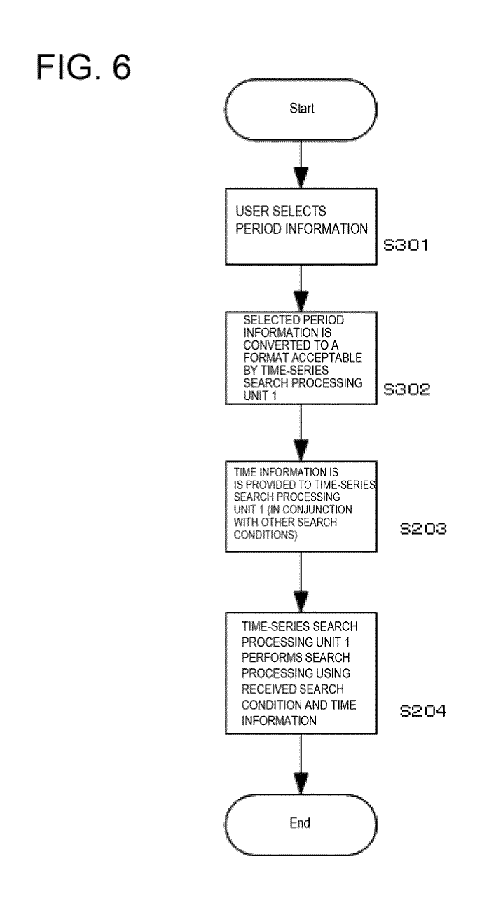

Step S105 has two types of operation modes which will be described later in detail using the flowcharts in FIG. 5 and FIG. 6.

After step S105, the time-series search processing unit 1 provides the obtained search result to the time-series search input/output unit 2 (step S106). Finally, the time-series search input/output unit 2 presents the received search result to the user (step S107).

### <Description of Two Patterns in Step S105>

The processing in step S105 depends on the interface that is used: the interface in which the user specifies a time (FIG. 5) or the interface in which the user selects period information (FIG. 6).

The exemplary embodiment may also be configured in such a way that both interfaces (time specification and period information selection) indicating the procedures in FIG. 5 and FIG. 6 are provided to allow the user to select one of them.

### <Time Specification>

First, referring to the flowchart in FIG. 5, the following describes the procedure executed when the user enters a search condition via an interface, in which the user specifies a time, for performing the search processing.

The interface in which the user specifies a time refers to an interface in which the slide bar (the time is determined by the position of the slide bar) is used as in the example in FIG. 3, an interface in which the user selects a time from a calendar or a clock, or an interface in which a character string is entered as the date.

First, the user references the presented period information and specifies a time that is entered as the search condition (step S201 in FIG. 5).

Next, the time-series search input/output unit 2 converts the time input, received from the user, to a format acceptable by the time-series search processing unit 1 (step S202).

This processing means that, when the time-series search input/output unit 2 has a time-specification search unit as an API (Application Interface), the user input is converted to a format satisfying the requirements of the arguments of the API.

In addition, the time-series search input/output unit 2 provides the time information and other search condition (received search keyword, etc.), which are converted in step S202, to the time-Series search processing unit 1 (step S203).

The time-series search processing unit 1 performs the search processing using the received time information and search condition (step S204).

### <Time Specification by Selecting Period Information>

Next, referring to the flowchart in FIG. 6, the following describes the search processing procedure executed when a time is specified by selecting period information.

First, the user selects one or more pieces of period information presented by the time-series search input/output unit 2 (step S301 in FIG. 6).

Next, the selected period information is converted to time information indicated by the period information. This time information may be the time information that is provided, when the period information is delivered from the period information presentation unit 3 to the time-series search input/output unit 2, or appropriate time information may be retrieved by accessing the period information accumulation unit 5.

The acquired time information is converted, if necessary, to a format acceptable by the time-series search processing unit 1 (This is the same processing as that in step S202).

The subsequent procedure is the same as that in steps S203 and S204 in FIG. 5 and so the description is omitted here.

### <Period Information Extraction Processing>

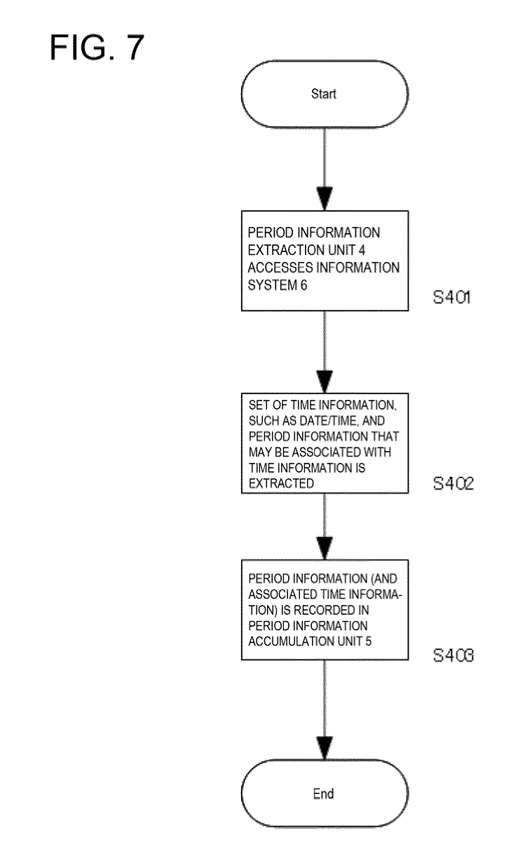

Next, the following describes the flow of the operation of the period information extraction processing with reference to the flowchart in FIG. 7.

First, the period information extraction unit 4 accesses the information system 6 to extract period information (step S401 in FIG. 7).

Instead of accessing the information system 6, the period information extraction unit 4 may extract period information using the information some other system has accessed and stored.

For example, a crawler is generally used in search engines to collect WWW pages. When the pages collected by this crawler are as the information system 6, the period information extraction unit 4 is required to access the data held by the crawler.

Next, the period information extraction unit 4 extracts a date/time and the corresponding period information from the information stored in the accessed information system 6 (step S402). As an example of this processing, the predetermined format of the information system 6 may be used.

For example, the following processing is performed when a news site is used as the information system 6. In a news site, the title of news and the date (as well as time in some cases) are linked and displayed. {If they are not known even after the analysis of the contents of web pages, the date column and the title column in the meta-tag of the web pages may be used}.

A part or the entirety of the title is extracted as the period information, and the time information related to the period information is extracted.

Finally, the period information and the time information extracted in step S402 are recorded in the period information accumulation unit 5 (step S403).

Repeating periodically the procedure shown in FIG. 7 allows the user to add new period information and to update the period information. The cycle of this repetition may be set arbitrarily.

It is also possible to extract period information when a change is detected in the information stored in the information system 6. Doing so reflects the period information quickly on the UI of the time-series search input/output unit 2.

### Effect of the Exemplary Embodiment

The following describes the effect of the present exemplary embodiment.

The present exemplary embodiment is configured in such a way that the period information extraction unit 4 extracts period information from the information system 6 and the extracted period information is presented on the time-series search input/output unit 2 to help the user enter a time condition. This configuration allows the user to select (or browse) the period information and enter a time condition even if the user does not remember an actual time condition.

### First Modification of First Exemplary Embodiment

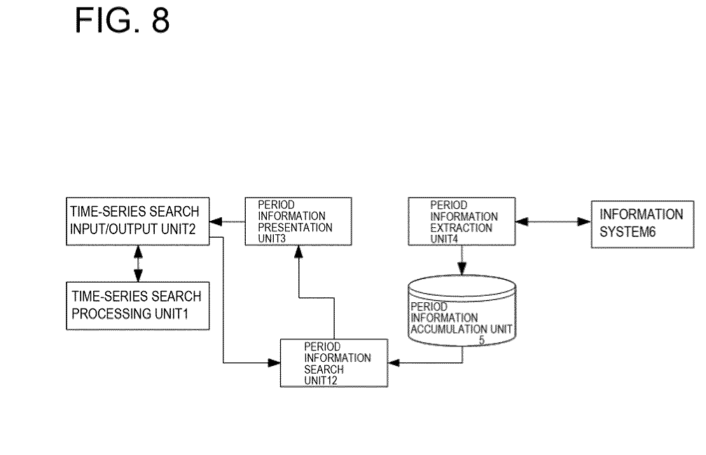

FIG. 8 is a diagram showing a first modification of the first exemplary embodiment of the present invention. In this modification, the period information to be presented is limited by searching for the historical background information. The configuration of this first modification is similar to the configuration shown in FIG. 1 except that a period information search unit 12 is added. Except for this, the configuration and the operation are the same as those of the first exemplary embodiment and so their description is omitted here. The following describes only the difference.

The period information search unit 12 limits the period information that the period information presentation unit 3 presents to the time-series search input/output unit 2. More specifically, the first modification of the present exemplary embodiment solves the following problem. When the time-series search input/output unit 2 provides an interface such as that shown in FIG. 2 to prompt the user to select from several pieces of information and if the amount of period information is large, the user sometimes finds it difficult to select a desired one. In this case, there is a need to limit the period information to be presented in some way or other by searching for period information.

The period information search unit 12 may be configured by a search engine that can perform the search processing using a character string included in the period information.

First, via the UI (User Interface) provided by the time-series search input/output unit 2, the user enters a search keyword used for limiting the period information.

The period information search unit 12 accepts the keyword, searches through the period information accumulated in the period information accumulation unit 5 and extracts the period information that includes the corresponding keyword. The period information search unit 12 presents only the extracted period information list to the time-series search input/output unit 2.

In addition, when a keyword for searching for the period information is not entered explicitly, the period information search unit 12 may be controlled so that the period information is limited using an ordinary keyword (keyword that is supplied to the time-series search processing unit 1).

The effect of this first modification is that the presented period information is limited when a large amount of period information is presented to help the user easily find the period information the user wants to select.

### Second Modification of First Exemplary Embodiment

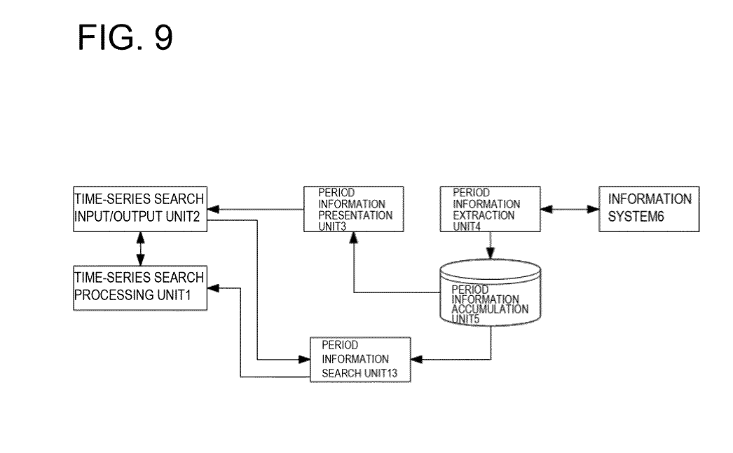

FIG. 9 is a diagram showing the configuration of a second modification of the first exemplary embodiment. In the second modification, an ordinarily entered keyword is used to specify a time. The configuration of this second modification is similar to the configuration of the first exemplary embodiment shown in FIG. 1 except that a period information search unit 13 is added.

The operation of the period information search unit 13 of the second modification differs from the operation of the period information search unit 12 in the first modification. That is, in this modification, the period information search unit 13 receives a search keyword accepted by the time-series search input/output unit 2 (keyword supplied to the time-series search processing unit 1), searches through the period information saved in the period information accumulation unit 5, and provides the time information, corresponding to the period information detected in the search, as the time information required by the time-series search processing unit 1.

The time-series search input/output unit 2 is only required to have the function that at least accepts a search keyword and provides the accepted keyword to the period information search unit 13 and the time-series search processing unit 1.

The time-series search input/output unit 2 may provide the whole accepted keyword to the period information search unit 13 or only a keyword to which a particular tag is attached (a character string specified, for example, as “time (keyword)”) to the period information search unit 13.

The time-series search processing unit 1 accepts the time information, not from the time-series search input/output unit 2, but from the period information search unit 13. Except for this, the configuration and the operation are the same as those of the first exemplary embodiment described above and so their description is omitted here.

The effect of the second modification is that the time-series search input/output unit 2 is not required to select period information or specify a time. The reason is that a time may be specified at search time by an ordinarily entered keyword.

### Second Exemplary Embodiment

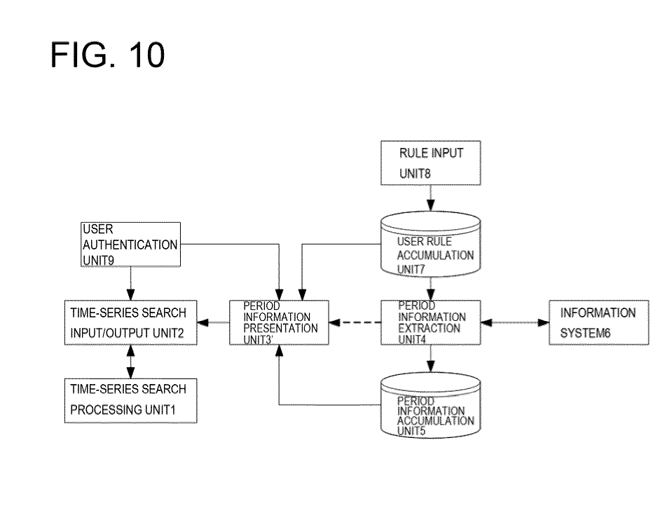

Next, a second exemplary embodiment of the present invention will be described below. FIG. 10 is a diagram showing the configuration of the second exemplary embodiment of the present invention. Referring to FIG. 10, the second exemplary embodiment of the present invention comprises a time-series search processing unit 1, a time-series search input/output unit 2, a period information presentation unit 3′, a period information extraction unit 4, a period information accumulation unit 5, an information system 6, a user rule accumulation unit 7, a rule input unit 8, and a user authentication unit 9. The general operation of those units is as follows.

The operation of the time-series search processing unit 1, time-series search input/output unit 2, period information accumulation unit 5, and information system 6 is the same as that of the first exemplary embodiment and so the description is omitted here.

### <Period Information Presentation Unit 3′>

The period information presentation unit 3′ is basically the same as the period information presentation unit 3 in the first exemplary embodiment. The difference is that, when period information is retrieved from the period information accumulation unit 5 and supplied to the time-series search input/output unit 2, the period information presentation unit 3′ reads a rule, prepared for a search user, from the user rule accumulation unit 7 and selects period information according to the rule prepared for the user.

### <Period Information Extraction Unit 4>

The period information extraction unit 4 accesses the information system 6 to extract period information. Basically, the period information extraction unit 4 performs the same operation as that of the period information extraction unit 4 in the first exemplary embodiment except that the period information extraction unit 4 in the present exemplary embodiment reads the period information extraction rule of each user from the user rule accumulation unit 7 and extracts information according to the rule that has been read. For the period information that differs from user to user, the period information accumulation unit 5 must store period information for each user.

The period information extraction unit 4 may use user authentication information to access information unique to a user in the information system 6. This means that user-unique information may be used as the period information.

### <User Rule Accumulation Unit 7>

The user rule accumulation unit 7 stores the period information extraction and presentation rule of each user received by the rule input unit 8.

### <Rule Input Unit 8>

The rule input unit 8 performs the function to receive the rule of each user and record the received rule in the user rule accumulation unit 7.

### <User Authentication Unit 9>

The user authentication unit 9 authenticates a search user, and performs the function to authenticate a user for using the time-series search input/output unit 2 and the time-series search processing unit 1 and the function to present login user information to the period information presentation unit 3′.

### <Example of Rules>

The following describes an example of a user rule. The simplest rule is that the information system 6, from which period information is extracted, is changed for each user.

For example, the storage location where user's monthly report file is saved is described in the rule. The period information extraction unit 4 accesses the monthly report of each user, extracts period information from the monthly report, and stores a combination of the period information and the time information for each user in the period information accumulation unit 5.

This operation makes it possible to implement a system where period information, created using the monthly report prepared by a user, may be used only by that user for the time-series search.

### <Effect of Operation>

According to the second exemplary embodiment of the present invention, the period information suitable for each search user may be presented. The reason is that a rule is specified for each user and period information is presented according to the rule.

### Third Exemplary Embodiment

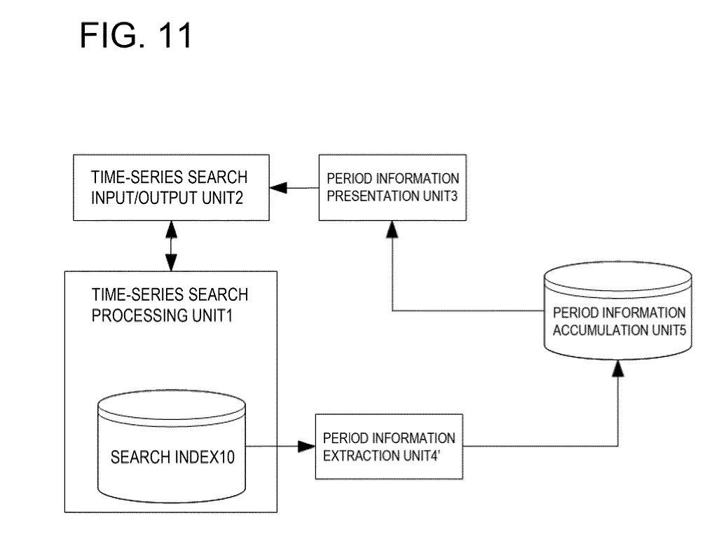

Next, a third exemplary embodiment of the present invention will be described. FIG. 11 is a diagram showing the configuration of the third exemplary embodiment of the present invention. In the third exemplary embodiment of the present invention, period information is extracted from the index of the search engine. Referring to FIG. 11, the third exemplary embodiment comprises a time-series search processing unit 1, a search index 10 held by the time-series search processing unit 1, a time-series search input/output unit 2, a period information presentation unit 3, a period information extraction unit 4′, and a period information accumulation unit 5. The general operation of those units is as follows.

The operation of the period information extraction unit 4′ differs from the operation of the period information extraction unit 4 in the first exemplary embodiment. Except for this, the operation of the time-series search processing unit 1, time-series search input/output unit 2, period information presentation unit 3, and period information accumulation unit 5 is the same as that of the first exemplary embodiment and so the description is omitted here.

### <Period Information Extraction Unit 4′>

The period information extraction unit 4′ accesses the search index 10, extracts period information from the search index, and saves the extracted period information in the period information accumulation unit 5. In the present exemplary embodiment, the search index 10 is used as the information system of the information extraction unit 4 in the first exemplary embodiment described above.

The following describes the operation of the period information extraction unit 4′ in detail.

The period information extraction unit 4′ uses the search index 10 to search for documents in which information indicating a time occurs (for example, a character string indicating a date).

Because the search index 10 usually includes occurrence positions of the words included in a document, the occurrence position is used to retrieve a word occurring around the position and this word is specified as the period information. The information indicating a time is recorded in the period information accumulation unit 5 as the time information corresponding to the period information.

It is also possible that a character string such as a character string list ‘“character string indicating a time”+“particle”+“some morpheme”’ is extracted (or a rule similar to this may be used) and that the extracted morpheme is used as the period information.

A threshold may also be defined for registering period information, for example, the period information is registered only when the same rule is satisfied in at least a predetermined number of documents.

### <Effect of Operation>

The third exemplary embodiment of the present invention eliminates the need for preparing an information system separately from the search system as in the first exemplary embodiment described above, allowing the search system to be operated singly.

### Modification of Third Exemplary Embodiment

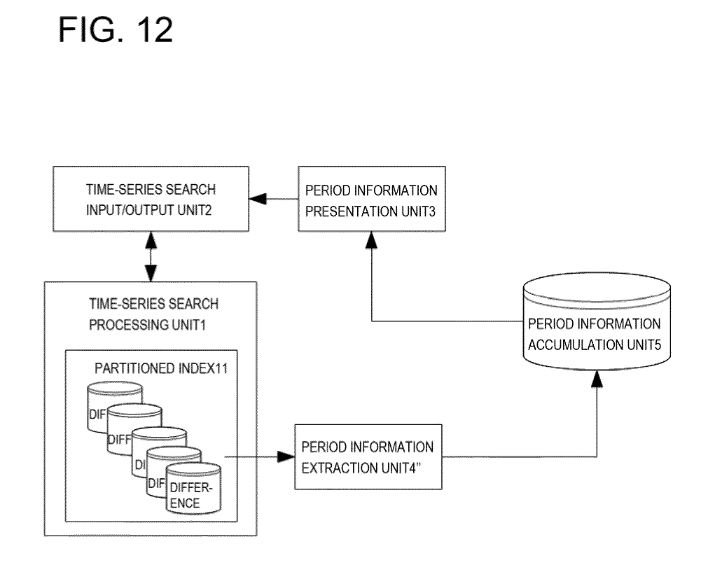

FIG. 12 is a diagram showing the configuration of a modification of the third exemplary embodiment of the present invention. In this modification, a partitioned index 11 is used as a search index of the time-series search processing unit 1 that a period information extraction unit 4″ uses for the search. In FIG. 12, the partitioned index 11, created by dividing the index on a time-series basis, is used as the search index as shown in FIG. 14.

The basic operation is the same as that of the third exemplary embodiment described above except the operation of the period information extraction unit 4″. Because the partitioned index 11 is an index created by dividing the search index 10 on a time series basis, each divided index of the partitioned index 11 includes information representing time information.

In addition, the index of the search engine holds information, such as the occurrence frequency of words in a set of documents, for calculating the scores.

Therefore, a word that occurs frequently and characteristically in each divided index may be extracted easily.

The period information extraction unit 4″ in this modification extracts a word, which occurs frequently and characteristically in this divided index, as period information. The time zone, in which the index is used as an index to be updated, is specified as the time information corresponding to the period information.

With the operation as described above, the information on a temporal deviation in keyword occurrences in a document set, for which the time-series search processing unit 1 will perform the search processing, may be used as the period information.

This modification has the effect that, because the index is already temporally divided, the analysis processing for extracting period information may be performed quickly.

The first and second modifications of the first exemplary embodiment described above are applicable also to the third exemplary embodiment of the present invention and its medication.

### Fourth Exemplary Embodiment

FIG. 15 is a diagram showing the configuration of a fourth exemplary embodiment of the present invention. The present exemplary embodiment is configured in such a way that the first exemplary embodiment described above cooperates with a scheduler system. The present exemplary embodiment allows a user to search for information using a time axis as in the first exemplary embodiment described above and, in addition, works with a scheduler system to solve the problem that the user sometimes finds it difficult to remember a date/time or a specified date/time to which the user wants to go back. To enable the user to specify a base point date/time to which the user wants to go back, a scheduler is used as a front end. A search interface is implemented on a scheduler system, and an input BOX and a button are provided for each day on the user interface (screen) of the scheduler for use as the range specification interface.

Referring to FIG. 15, a time-series search processing unit 21 corresponds to the time-series search processing unit 1 in FIG. 1, and a time-series search input/output unit 22, a schedule presentation unit 23, and a schedule input unit 24 correspond respectively to the time-series search input/output unit 2, period information presentation unit 3, and period information extraction unit 4 in FIG. 1.

A schedule DB 25, which stores the schedules maintained by a scheduler system 20, corresponds to the period information accumulation unit 5 in FIG. 1. The schedule DB 25 stores schedule information on users and organizations entered from the schedule input unit 24.

The schedule presentation unit 23 provides information, read from the schedule DB 25, to a user 27. The schedule presentation unit 23 may provide the information also to the time-series search input/output unit 22.

In the present exemplary embodiment, the time-series search input/output unit 22, schedule presentation unit 23, and schedule input unit 24 serve as a user interface. Although each unit may be independent, the three units function as one user interface in the present exemplary embodiment.

In the configuration shown in FIG. 1 where user input/output is processed by the time-series search input/output unit 2, the information output from the period information presentation unit 3 is supplied to the time-series search input/output unit 2. In contrast, in the present exemplary embodiment shown in FIG. 15, the three units 22, 23, and 24 serve as a user interface.

The schedule input unit 24 accepts a schedule input of each user from the user 27 or other information systems 26. This processing corresponds to the processing in which period information is extracted from the information system 6 in the first exemplary embodiment described above.

In the present exemplary embodiment, one of the information systems 6 in FIG. 1 is replaced by the user 27 (input from a user terminal), and the processing of the period information extraction unit 4 in the first exemplary embodiment described above corresponds to the processing in which the user 27 enters a schedule (period information). The schedule of the user 27 may be entered, not from the user 27, but from other information systems 26 (for example, other operation systems).

An information system registers schedules (period information) in the scheduler system 20 via the API provided by the scheduler system 20.

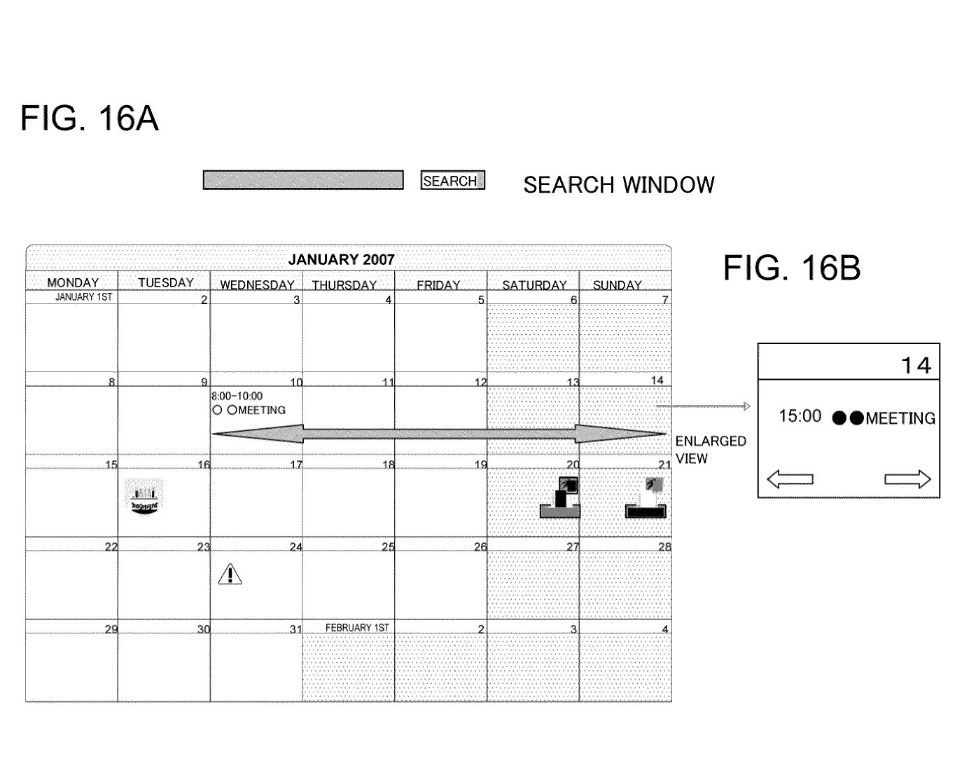

FIG. 16 is a diagram showing an example of the user interface (UI) of the scheduler system shown in FIG. 15. This example shows the user interface of a calendar-type scheduler system. The schedule presentation unit 23 in FIG. 15 presents a calendar and schedule information, stored in the schedule DB 25, on a user screen.

The time-series search input/output unit 22 combines the search window and the time specification interface with the screen provided by the schedule presentation unit 23. This combination processing may be performed by the user side, or the schedule presentation unit 23 may operate as a wrapper of the time-series search input/output unit 22. Alternatively, the time-series search input/output unit 22 may operate as a wrapper of the schedule presentation unit 23 as in the first exemplary embodiment described above.

As an example of the time specification interface, the specification buttons are provided in the space reserved for each date. FIG. 16B shows an enlarged view of the date column of a day. Left and right arrows are specification buttons, respectively. Clicking on the left arrow button requests the time-series search processing unit 21 to search for information before the day. Clicking on the right arrow button requests the time-series search processing unit 21 to search for information after the day.

The dates of a search range may be specified by clicking on the right arrow at the start of the search range dates and clicking on the left arrow at the end.

The arrow in the calendar in FIG. 16A indicates how the dates of a search range are specified. The time-series search input/output unit 22 provides the date specification and the search keyword, specified via the user interface such as the one shown in the figure, to the time-series search processing unit 21 and waits for a response. In the present exemplary embodiment, the system cooperates with the scheduler system to allow the user to use a daily schedule as period information, thus making the user feel a date specification easier to use.

In the present exemplary embodiment, the user can enter search data via the scheduler system to set a time axis, on which the search is to be based, using the information, displayed by the scheduler system, with no need to remember an actual date. As a result, the user finds it easier to reach desired information. This system also eliminates the need for the user to remember or investigate actual date/time information.

### INDUSTRIAL APPLICABILITY

The present invention is applicable to the user interface of an information retrieval apparatus or an information retrieval program into which time axis information, such as a date or a time, is entered. The present invention is applicable not only to an information retrieval system but also to a system where time-axis information, such as a date or a time, must be entered.

The disclosures of Patent Documents and Non-Patent Document given above are incorporated by reference into this specification. The exemplary embodiments and the examples may be changed and adjusted in the scope of the entire disclosure (including claims) of the present invention and based on the basic technological concept thereof. In the scope of the claims of the present invention, various disclosed elements may be combined and selected in a variety of ways. That is, the present invention of course includes modifications and changes that may be made by those skilled in the art based on the entire disclosure including the claims as well as the technological concept thereof.

What is claimed is:

1. An information presentation system comprising:
a search unit that selects a search index based on time information, which is used as a search base point, to perform a search processing, the search index being partitioned on a time-series basis; and
an extraction unit that extracts period information from a predetermined information source, the period information including information which serves as a marker of time information, wherein
the search unit performs the search processing according to the period information extracted by the extraction unit.

2. The information presentation system according to claim 1, wherein the is predetermined information source includes
an information system.

3. The information presentation system according to claim 1, further comprising
a presentation unit that presents the period information extracted by the extraction unit.

4. The information presentation system according to claim 3, further comprising
a period information accumulation unit that records therein the period information extracted by the extraction unit.

5. The information presentation system according to claim 4, further comprising
a period information input/output unit that changes the period information, extracted by the extraction unit, and/or registers the period information in the period information accumulation unit.

6. The information presentation system according to claim 4, further comprising
a period information search unit that accepts a search keyword which is received via a user interface, and which limits the period information, searches through the period information recorded in the period information accumulation unit, is extracts the period information including the keyword, and outputs the extracted period information to the presentation unit.

7. The information presentation system according to claim 4, further comprising
a period information search unit that receives a search keyword, searches through the period information recorded in the period information accumulation unit, using the search keyword, and provides time information, which is made to correspond to the period information acquired by the search, to the search unit.

8. The information presentation system according to claim 3, wherein, in performing information retrieval with time information specified as a search condition, the search unit uses the period information, which is presented by the presentation unit and selected by a user, as time information of a search condition to eliminate a need for searching for time information used as the search condition.

9. The information presentation system according to claim 3, further comprising
a search input/output unit that enters a search condition into the search unit and receives a search result from the search unit.

10. The information presentation system according to claim 9, wherein the search input/output unit presents the period information, presented by the presentation unit, to a user via an interface.

11. The information presentation system according to claim 9, wherein the search input/output unit converts the period information selected by a user to a format acceptable by the search unit and enters the converted period information into the search unit.

12. The information presentation system according to claim 9, wherein the presentation unit provides the period information, extracted by the extraction unit, to the search input/output unit,
the search input/output unit presents the period information to a user, and
when the user enters time information into the search unit as a search condition, the presented period information is made available for use as information for determining time information.

13. The information presentation system according to claim 1, wherein the extraction unit extracts the period information using an index, included in the search unit, as the information source.

14. The information presentation system according to claim 1, wherein the extraction unit selects the index, which is partitioned on a time-series basis, for a search based on search base-point time information and extracts the period information.

15. The information presentation system according to claim 3, further comprising
a user rule accumulation unit that stores rules for extracting the period information according to users, wherein
the extraction unit extracts the period information from the information source based on a user-specific rule stored in the user rule accumulation unit.

16. The information presentation system according to claim 3, further comprising
a user rule accumulation unit that stores rules for presenting the period information according to users, wherein
the presentation unit presents the period information, extracted by the extraction unit, based on a user-specific rule stored in the user rule accumulation unit.

17. The information presentation system according to claim 3, further comprising
a user authentication unit that authenticates a user, who uses the search unit, and presents information on a login user to the presentation unit.

18. The information presentation system according to claim 1, wherein the predetermined information source includes
a scheduler system.

19. The information presentation system according to claim 4, further comprising
a scheduler system that accepts schedule information, which is entered by a user or acquired from the information source, and registers the schedule information in a scheduler database, wherein
the schedule information is used as the extracted period information,
the scheduler database is used as the period information accumulation unit in which the period information is recorded, and
the presentation unit presents the period information from the scheduler database and provides the period information to the search unit.

20. The information presentation system according to claim 3, wherein the extraction unit extracts the period information from a search index included in the search unit.

21. The information presentation system according to claim 1, further comprising
an index registration unit that creates an index of search target documents, held by a document storage unit that holds search target documents, and registers the created index in a latest index.

22. An information presentation method comprising:
extracting period information from a predetermined information source, the period information including information which serves as a marker of time information; and
in performing a search processing by selecting a search index based on the time information to be used as a search base point, the search index being partitioned on a time-series basis, performing the search processing according to the extracted period information.

23. A computer-program causing a computer to execute the processing comprising:
extracting period information from a predetermined information source, the period information including information which serves as a marker of time information; and
in performing a search processing by selecting a search index based on the time information to be used as a search base point, the search index being partitioned on a time-series basis, performing the search processing according to the extracted period information.

24. A computer-readable storage medium storing a program causing a computer to executes the processing comprising:
extracting period information from a predetermined information source, the period information including information which serves as a marker of time information; and
in performing a search processing by selecting a search index based on the time information to be used as a search base point, the search index being partitioned on a time-series basis, performing the search processing according to the extracted period information.
